(19) United States
(12) Patent Application Publication
(10) Pub. No.: US 2005/0253525 A1
(43) Pub. Date: Nov. 17, 2005

(54) Tubular dielectric barrier discharge lamp and method for its production

(75) Inventor: Jorg Rink, Syrgenstein (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/122,065

(22) Filed: May 5, 2005

(30) Foreign Application Priority Data
May 12, 2004 (DE) 10 2004 023 460.4

(51) Int. Cl. H01J 61/30

(52) U.S. Cl. 313/634

(57) ABSTRACT

A tubular dielectric barrier discharge lamp having a discharge vessel and at least one inner wall electrode has, at least at one end, a constriction 9, which extends along the entire circumference of the discharge vessel and tapers in the direction opposite to the interior of the discharge vessel. The constriction 9 serves the purpose of sealing this end of the discharge vessel in a gas-tight manner via a closure element 4, which is in the form of an exhaust plate and is inserted at this point. The tapering of the discharge tube for the purpose of forming the constriction 9 prevents or at least markedly reduces any negative effect of the electrode spacing and/or the thickness of the dielectric coating of the electrodes in the region of the discharge space which is immediately adjacent to the constriction 9.

### TECHNICAL FIELD

The invention is based on a dielectric barrier discharge lamp having a tubular discharge vessel, which has at least one electrode, which is arranged on the inner wall of the tubular discharge vessel and is also referred to below for short as an inner wall electrode.

Lamps of the generic type are used in particular in devices for office automation (OA), for example color copiers and scanners, for signal lighting, for example as a brake light and indicator light in automobiles, for auxiliary lighting, for example interior lighting of automobiles, and also in combination with plate-like fiberoptic cables for flat background lighting of displays, for example liquid crystal displays, as so-called “edge-type backlights”.

### BACKGROUND ART

The specification U.S. Pat. No. 6,605,899 B2 has already disclosed such a lamp. It has two elongate electrodes, which are arranged diametrically parallel to the lamp longitudinal axis on the inner wall of the discharge tube. Both inner wall electrodes are covered with a dielectric layer. At one end, the discharge tube is sealed in a gas-tight manner with the aid of a plate-like closure element. In this case, the discharge tube has, at one end along the entire circumference, a constriction, which is U-shaped in profile and which annularly surrounds the edge of the plate-like closure element. With the aid of this annular constriction, the plate-like closure element is connected in a gas-tight manner over its entire circumference directly to the inner wall of the discharge tube. The two linear electrodes are passed to the outside in a gas-tight manner through this point in order to be able to connect them to an electrical supply device.

One disadvantage is the fact that this lamp has a tendency to form a filament-like discharge form on ignition, and this discharge form, as has been shown in tests, has its origin in the region of this closure element. Filament-like discharge forms lead to a physically and temporally inhomogeneous luminance distribution along the lamp and are therefore undesirable. For practically all application fields, in particular for background lighting and for office automation, a homogeneous luminance distribution is indispensable.

### DISCLOSURE OF THE INVENTION

The object of the present invention is to provide a tubular dielectric barrier discharge lamp having at least one electrode, arranged on the inner wall, which has improved operational performance.

This object is achieved by a dielectric barrier discharge lamp having a tubular discharge vessel comprising a discharge tube, which is sealed at both of its ends and has an annular constriction at at least one end along the entire circumference, elongate electrodes, at least one electrode being arranged on the inner wall of the discharge tube, at least one closure element, which has a plate-like section, the or each closure element being arranged at the respective end within the discharge tube, and the plate-like section being connected in a gas-tight manner over its entire circumference to the inner wall of the discharge tube in the region of the annular constriction, the constriction having a section in which the discharge tube tapers in the direction opposite to the interior of the discharge vessel.

In addition, protection is claimed for a method for producing this lamp in accordance with the features of the method claim.

For the present state of knowledge, it is assumed that the constriction, which is U-shaped in profile and is proposed in U.S. Pat. No. 6,605,899 B2 mentioned initially, has a negative effect on the directly adjoining region of the discharge space, in particular reduces the mutual spacing between the inner wall electrodes and/or the thickness of the dielectric coating of the electrodes. In both cases, it is highly probable at this point that discharge filaments will be produced.

Owing to the flat transition between the narrowest point of the constriction and that part of the discharge tube which adjoins said constriction, that section of the constriction which tapers in the direction opposite to the interior of the discharge vessel (or when viewed the other way around that section which opens in the direction of the vessel interior) effectively prevents the constriction, which is indispensable per se for sealing purposes, from reaching into the interior of the discharge vessel, i.e. the discharge space. The tapering of the discharge tube according to the invention for the purpose of forming the constriction thus prevents or at least markedly reduces any negative effect of the electrode spacing and/or the thickness of the dielectric coating of the electrodes.

The axial extent of the tapering section of the annular constriction is preferably equal to or greater than the axial extent of the plate-like section of the closure element along the inner wall of the discharge tube.

The tapering section is preferably formed such that the axial position of the narrowest point of the annular constriction is in the vicinity of that end of the plate-like section of the closure element which faces away from the interior of the discharge vessel. The axial position of the narrowest point of the annular constriction, when viewed from the interior of the discharge vessel, is particularly preferably behind the plate-like section of the closure element.

In a form which is preferred because it is simple, the tapering section is in the form of a bevel extending along the entire circumference of the discharge tube. In this case, the angle enclosed by the bevel and the longitudinal axis of the discharge tube, when viewed in longitudinal section, opens into the interior of the discharge vessel. In this preferred embodiment, the constriction is similar to an asymmetric V, the longer and therefore flatter limb corresponding to the bevel according to the invention i.e. facing the interior of the discharge vessel.

In addition, it has proved advantageous to select the angle of the bevel with respect to the longitudinal axis of the discharge tube to be greater than 50, in particular greater than 100, in order to reliably prevent the negative effect mentioned.

### BRIEF DESCRIPTION OF THE DRAWINGS

The invention will be explained in more detail below with reference to an exemplary embodiment. In the figures:

FIG. 1a shows a side view of a dielectric barrier discharge lamp according to the invention,

FIG. 1b shows an end view of the lamp shown in FIG. 1a,

FIG. 1c shows a cross-sectional view of the lamp shown in FIG. 1a along the line BB,

FIG. 1d shows a longitudinal sectional view of the lamp shown in FIG. 1a along the line AA drawn in FIG. 1b,

FIG. 1e shows an enlarged illustration of an end X of the lamp shown in FIG. 1d,

FIG. 1f shows an enlarged illustration of the other end Y of the lamp shown in FIG. 1d,

FIG. 2 shows a pressure roller for the purpose of forming the curve in the lamp according to the invention shown in FIGS. 1a-1f, and

FIG. 3 shows a pressure roller according to the prior art.

### BEST MODE FOR CARRYING OUT THE INVENTION

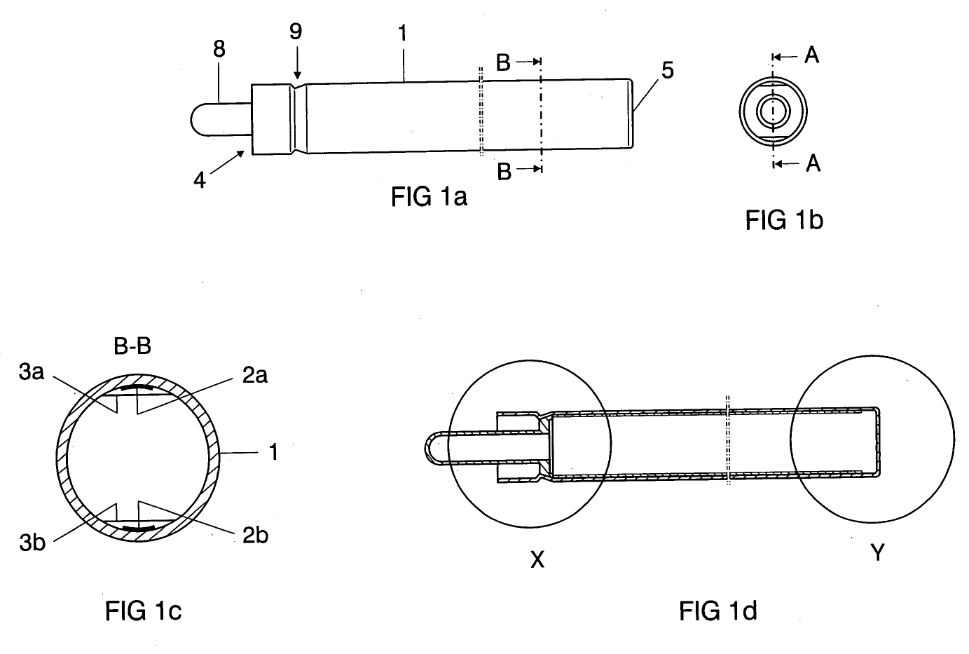

Reference will be made below to FIGS. 1a to 1f, where the technical features of the dielectric barrier discharge lamp according to the invention are illustrated schematically.

The discharge vessel of the lamp essentially comprises a discharge tube 1 made of soda-lime glass (for example glass No. 360 by Philips and/or AR-Glas by Schott), which has an outer diameter of approximately 10 mm and a length of approximately 390 mm. Two linear inner wall electrodes 2a, 2b made of silver and having a thickness of approximately 10 μm and a width of approximately 1 mm are fitted diametrically to the inner wall of the discharge tube 1 (only shown in FIG. 1c). Each electrode 2a, 2b is covered with a strip-like dielectric barrier 3a, 3b made of glass solder, and having a thickness of approximately 350 μm and a width of approximately 3.5 mm. The discharge tube 1 is sealed at a first end X (see also the enlarged illustration in FIG. 1e) with a closure element 4 and at its other end Y (see also the enlarged illustration in FIG. 1f) by means of a fused butt joint 5. The closure element 4 has a plate-like section 6 having a central hole 7, on which an exhaust tube 8, which is sealed at one end, is integrally formed. At the first end X, the discharge tube 1 has an annular constriction 9, which is passed around the edge, or more precisely around the circumferential face of the plate-like section 6 of the closure element 4, said circumferential face and the inner wall of the discharge tube which is in contact with said circumferential face being fused to one another in a gas-tight manner. The two linear inner wall electrodes 2a, 2b are passed to the outside in a gas-tight manner through this fused zone (not shown in FIGS. 1a -1f). Outside the discharge vessel, the two linear electrodes end in each case in a soldered face 10a, 10b, which are provided for connecting power supply lines of an electrical supply device (not shown). The annular constriction 9 has a circumferential bevel 11, which forms an angle of approximately 14° with the longitudinal axis of the discharge tube 1. In this case, the bevel is oriented such that, in this region, the discharge tube tapers in the direction opposite to the interior of the discharge vessel. The axial extent of the bevel 11 is approximately 2 mm and is thus greater than the axial extent of the circumferential face of the plate-like section 6, which is approximately 1 mm. The axial extent of the entire constriction 9 is approximately 3 mm. In addition, the circumferential bevel 11 is positioned such that it completely covers the circumferential face of the plate-like section 6. This makes it possible for the narrowest point 12 of the circumferential constriction 9 to be in the vicinity of that edge of the plate-like section 6 of the connecting element 4 which faces away from the interior of the discharge vessel, or more precisely slightly after this edge. At the narrowest point 12, the depth of the constriction is approximately 0.5 mm. The discharge vessel is filled with 15 kPa of xenon and 45 kPa of neon.

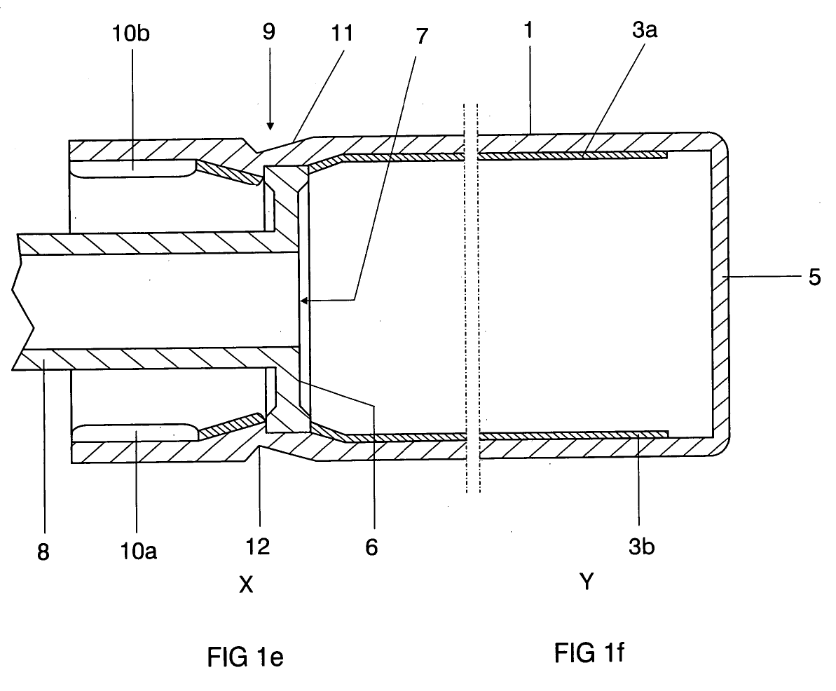

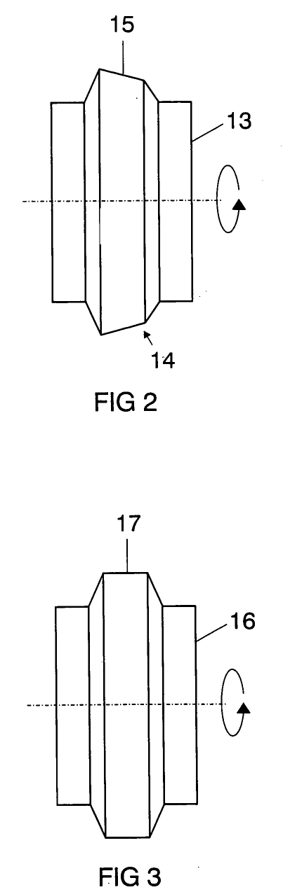

FIG. 2 illustrates a pressure roller 13 made of a high-melting material, which is used in the production of the lamp according to the invention, which is illustrated in FIGS. 1a-1f, for the purpose of forming the constriction 9 when the lamp is sealed at its first end X. The pressure roller 13 has a circumferential, asymmetrically pointed, shaped section 14, which is delimited by a beveled pressure face 15. This beveled pressure face 14 serves the purpose of forming the bevel 11 for the constriction 9 of the lamp. For this purpose, that part of the wall of the discharge tube rotating about the longitudinal axis which has previously been softened is pressed on the edge of the plate-like section of the closure element with the aid of the pressure roller 13. For comparison purposes, a conventional pressure roller 16 with a horizontal pressure face 17 is shown in FIG. 3, as is used in the prior art for forming a U-shaped constriction. For further details relating to the method for producing the lamp and, in particular, the sealing technique with the aid of the plate-like connecting element, reference is made to the above-cited U.S. Pat. No. 6,605,899 B2.

Depending on the field of application, for example when used as an aperture lamp in OA devices, the wall of the discharge vessel may optionally be provided at least partially with fluorescent material.

1. A dielectric barrier discharge lamp having
a tubular discharge vessel comprising a discharge tube, which is sealed at both of its ends and has an annular constriction at at least one end along the entire circumference,
elongate electrodes, at least one electrode being arranged on the inner wall of the discharge tube,
at least one closure element, which has a plate-like section, the or each closure element being arranged at the respective end within the discharge tube, and the plate-like section being connected in a gas-tight manner over its entire circumference to the inner wall of the discharge tube in the region of the annular constriction,
the constriction having a section in which the discharge tube tapers in the direction opposite to the interior of the discharge vessel.

2. The dielectric barrier discharge lamp as claimed in claim 1, the axial extent of the section of the constriction, in which the discharge tube tapers in the direction opposite to the interior of the discharge vessel, being equal to or greater than the axial extent of the plate-like section of the closure element along the inner wall of the discharge tube.

3. The dielectric barrier discharge lamp as claimed in claim 1, the section of the constriction, in which the discharge tube tapers in the direction opposite to the interior of the discharge vessel, being formed such that the axial position of the narrowest point of the annular constriction is in the vicinity of that end of the plate-like section of the closure element which faces away from the interior of the discharge vessel.

4. The dielectric barrier discharge lamp as claimed in claim 1, the section of the constriction, in which the discharge tube tapers in the direction opposite to the interior of the discharge vessel, being formed such that the axial position of the narrowest point of the annular constriction, when viewed from the interior of the discharge vessel, is behind the plate-like section of the closure element.

5. The dielectric barrier discharge lamp as claimed in claim 1, the section of the constriction, in which the discharge tube tapers in the direction opposite to the interior of the discharge vessel, being in the form of a bevel extending along the entire circumference.

6. The dielectric barrier discharge lamp as claimed in claim 5, the angle of the bevel with respect to the longitudinal axis of the discharge tube being greater than 50, in particular greater than 10°.

7. The dielectric barrier discharge lamp as claimed in claim 1, at least one electrode, arranged on the inner wall of the discharge tube, being passed to the outside in a gas-tight manner in the region of the constriction through the connection between the inner wall and the circumferential face of the plate-like section of the closure element.

8. The dielectric barrier discharge lamp as claimed in claim 1, the plate-like section having an opening, and the closure element comprising an exhaust tube which is integrally formed on the opening.

9. The dielectric barrier discharge lamp as claimed in claim 1, the at least one electrode, arranged on the inner wall of the discharge tube, being covered by a dielectric layer.

10. A method for producing the discharge lamp as claimed in claim 1 having the following method steps:
providing a closure element having a plate-like section, whose diameter is smaller than the internal diameter of the discharge tube,
inserting the closure element at one end, which is to be sealed, of the discharge tube such that an annular gap remains between the plate-like section and the inner wall,
heating the closure element and the discharge tube in the region of the closure element up to the softening point,
constricting the heated region of the discharge tube so as to form a section which tapers in the direction opposite to the interior of the discharge vessel, the edge of the plate-like section of the closure element and the inner wall of the discharge tube being connected to one another in a gas-tight manner in the region of this section.

11. The method as claimed in claim 10, a pressure roller made of a high-melting material pressing the softened part of the wall of the discharge tube, which is rotating about the longitudinal axis, onto the edge of the plate-like section of the closure element so as to form the constriction, the pressure roller having a pressure face which is in the form of a bevel.

12. The dielectric barrier discharge lamp as claimed in claim 2, the section of the constriction, in which the discharge tube tapers in the direction opposite to the interior of the discharge vessel, being formed such that the axial position of the narrowest point of the annular constriction is in the vicinity of that end of the plate-like section of the closure element which faces away from the interior of the discharge vessel.

13. The dielectric barrier discharge lamp as claimed in claim 2, the section of the constriction, in which the discharge tube tapers in the direction opposite to the interior of the discharge vessel, being formed such that the axial position of the narrowest point of the annular constriction, when viewed from the interior of the discharge vessel, is behind the plate-like section of the closure element.

14. The dielectric barrier discharge lamp as claimed in claim 2, the section of the constriction, in which the discharge tube tapers in the direction opposite to the interior of the discharge vessel, being in the form of a bevel extending along the entire circumference.

15. The dielectric barrier discharge lamp as claimed in claim 2, at least one electrode, arranged on the inner wall of the discharge tube, being passed to the outside in a gas-tight manner in the region of the constriction through the connection between the inner wall and the circumferential face of the plate-like section of the closure element.

16. The dielectric barrier discharge lamp as claimed in claim 2, the plate-like section having an opening, and the closure element comprising an exhaust tube which is integrally formed on the opening.

17. The dielectric barrier discharge lamp as claimed in claim 2, the at least one electrode, arranged on the inner wall of the discharge tube, being covered by a dielectric layer.
